(19) United States
(12) Patent Application Publication
(10) Pub. No.: US 2005/0094263 A1
(43) Pub. Date: May 5, 2005

(54) Microscope slide designed for educational purposes

(76) Inventor: Vincent Vaccarelli, Getzville, NY (US)

Correspondence Address: Robert P. Simpson, Esq.;Simpson & Simpson, PLLC, 5555 Main Street, Williamsville, NY, 14221-5406, US

(21) Appl. No.: 10/698,506

(22) Filed: Oct. 31, 2003

(51) Int. Cl. G02B 21/34

(52) U.S. Cl. 359/396

(57) ABSTRACT

A microscope slide for educational purposes is disclosed. The microscope slide is made from a transparent material in a rectangular shape. The microscope slide defines at least a first and a second area, wherein the first area carries a preparation and the second area is provided with a non-transparent coating. A plurality of printed characters is carried on the non transparent coating.

### FIELD OF THE INVENTION

The present invention relates to a microscope slide for educational purposes.

### BACKGROUND OF THE INVENTION

The Lieder general catalogue Biology No.20E discloses prepared microscope slides. The Lieder prepared slides contain preparations of typical micro-organism, of cell division and of embryonic developments as well as of tissues and organs of plants, animals and man. The preparation in placed in the centers of the slide. On both sides of the slide stickers are attached on which information is written about the actual preparation. The problem with the stickers is that they can be pulled off or the adhesive may deteriorate and loose its holding force of the sticker.

The U.S. Pat. No. 6,381,031 discloses a test slide for the calibration, characterization, standardization, use and study of photon and electron microscopes. The slide is created by forming patterns with specific types of geometries on suitable substrates and these slides provide a standard for comparison of image forming capability of any type of microscope imaging system including, without limitation, light, UV, and X-ray photon microscopical imaging systems operating in transmission or reflection modes, and other microscope techniques. Microscopists can employ one of these slides to compare images of the slide which have been produced by the microscope system under consideration with a known, accurate, image of the slide to better understand the fidelity and accuracy of the microscope system under consideration. The test patterns can also comprise reference images which can be images created by a graphic artist or the like or which can be actual images of samples, these images being either two dimensional or three dimensional.

The U.S. Pat. No. 4,833,382 discloses a microscope slide and a slide carrier which are provided with cooperating elements for positioning the slide at a predetermined position and orientation with respect to the carrier. The slide is further provided with a reference mark for enabling an automatic monitoring of the position of the slide relative to the frame of the carrier during an inspection of the slide. The x and y coordinates relative to the slide carrier frame of a detected microscopic object are recorded. On a later occasion, the detected object can be easily relocated by fixing the slide to the carrier in the predetermined fixed position and orientation, shifting the slide carrier so that the reference mark appears in the visual field of the microscope being used, setting this position of the slide as a reference position, and moving the slide as well as the slide carrier from that reference position in accordance with the previously recorded x and y coordinates.

The U.S. Pat. No. 5,851,489 shows a specimen slide for a microscope, camera or other such observation device has a receiving area for cell or tissue samples or other such organic material and a smaller observation area for the organic material. The specimen slide at least in the observation area is made of transparent material. Within the receiving area the specimen slide is provided with thin-film sensors adjacent to the observation area for measuring physiological parameters of the organic material. The chemical and physical characteristics of the organic material under observation can be picked up by the sensors while it is observed, for example under a microscope.

The invention, as disclosed in WO 2001031383 relates to a transparent object carrier for use in optical microscopy, comprising a carrier side for the object to be microscoped and a visible linear grid for examining the latter. According to the invention, the linear grid is configured on a film which is applied to the opposite side of the object carrier from the carrier side.

A combination is disclosed in WO 1999053357, which comprises a slide suitable for optical microscopy to which a specimen is applied and an optically transparent cover adhered to the slide over the specimen, wherein the cover comprises: an optically transparent polymeric film having opposite first and second major surfaces; and a contact responsive adhesive on the first major surface and in contact with the slide.

The European Patent Application EP 1 034 450 relates to a sample holder which can process data. The inventive sample holder has two areas; a first area for receiving the sample and a second area for identifying the sample. Said second area is provided with a writeable, readable, non-volatile memory, for example a smart chip.

The German Patent Application DE 101 54 843 refers to a method and devices for the cross-referencing of identification of object supports, for microtomised analytical samples still to be mounted thereon, with identification information for a support of a tissue sample which is not yet microtomised. The conventional problem of cross-referencing is improved in a simple manner, whereby the identification information for the support is automatically generated during the very allocation in the microtome and an identification, corresponding thereto, is automatically transferred to at least one object support and that finally said object support, provided with the identification is given for the application of the microtomised tissue sample at the moment when a microtomised tissue sample must be applied to an object support.

The German Patent Application DE 199 05b490 discloses a detachable labeling device for slides comprising a stainless steel clip gripping slide readily slipped on and off, displaying an automatically-produced barcode label. A detachable label is not suitable for use in a teaching environment.

### SUMMARY OF THE INVENTION

It is therefore the object of the present invention to describe microscope slide for educational purposes which is durable, avoids damage and reduces the risk of pollution of the preparation by the user.

The above object is solved by a microscope slide comprising: a transparent material in a rectangular shape, at least a first and a second area defined on the microscope slide, wherein the first area carries a preparation and the second area is provided with a non-transparent coating, and a plurality of printed characters are carried on the non transparent coating.

The above object is as well solved by a microscope slide comprising: a transparent material in a rectangular shape, at least a first, a second and a third area defined on the microscope slide, wherein the first area carries a preparation and the second and the third area are provided with a non-transparent coating, a plurality of printed characters are carried on the second non transparent layer and a printed representation of the preparation on the microscope slide is provided on the third non transparent coating.

The above object is solved by a microscope slide for educational purposes comprising: a transparent material in a rectangular shape, at least a first, a second and a third area defined on the microscope slide, wherein the first area carries a preparation, the second area is provided with a non-transparent layer wherein a plurality of printed characters are carried on the second non transparent coating, and the third area carries a sticker on which a printed representation of the preparation on the microscope slide is shown.

It is advantages, that the plurality of printed characters on the at least one transparent layer comprises readable information. It is as well advantages, that the plurality of printed characters on the at least one transparent layer comprises readable information and machine readable information. The machine readable information can be in the form of a barcode, which would ease keeping track record of the microscope slides in an educational facility.

The microscope slide may have two distinct areas, wherein each of which is provided with a non-transparent coating. The two distinct areas with the non-transparent layer are arranged in that both non-transparent coatings are arranged on opposite ends of the microscope slide. In case of two non-transparent coatings one of the non-transparent coatings carries the plurality of printed characters in readable or machine readable form and the other non-transparent layer carries a printed representation of at least a portion of the preparation on the microscope slide.

Further advantageous embodiments of the invention are apparent from the dependent claims.

### BRIEF DESCRIPTION OF THE DRAWINGS

There are various ways of advantageously embodying and developing the teaching of the present invention. Reference is made to the drawings. In the drawings:

FIG. 1a schematically depicts a top view of one embodiment of the inventive microscope slide,

FIG. 1b schematically depicts a side view of the embodiment shown in FIG. 1a,

FIG. 2 shows a second embodiment of a microscope slide according to the present invention,

FIG. 3 shows a third embodiment of a microscope slide,

FIG. 4 shows an embodiment for the arrangement of the second area on the microscope slide,

FIG. 5 is a top view of a further embodiment of the present invention,

FIG. 6 is a top view of a further embodiment of the microscope slide with rounded corners,

FIG. 7 is a top view of a further embodiment of the arrangement of the non-transparent coatings,

FIG. 8 is an embodiment the microscope slide with a rectangular edge,

FIG. 9 is an embodiment of the microscope slide with a rounded edge

FIG. 10 is an embodiment of the microscope slide with a triangular edge, and

FIG. 11 is an embodiment of the microscope slide with a trapezoidal edge.

### DETAILED DESCRIPTION OF THE INVENTION

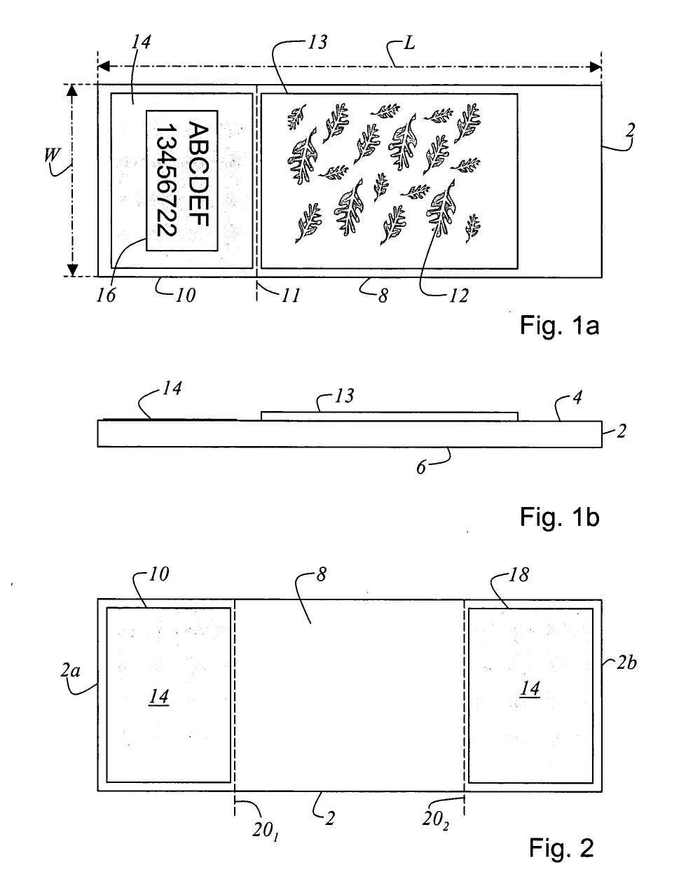

FIG. 1a shows schematically a top view of one embodiment of an inventive microscope slide 2. The microscope slide 2 is made of a transparent material and has a rectangular shape. The rectangular shape of the microscope slide 2 defines a length L and a width W. The microscope slide 2 has a top surface 4 and a bottom surface 6 (see FIG. 1b). A first area 8 and a second area 10 are defined on the top surface 4 of the microscope slide 2. A dashed line 11 marks the border between the first area 8 and the second area 10. The first area 8 carries a preparation 12, which is covers with a cover slip 13 and the second area 10 is provided with a non-transparent layer 14. The non-transparent layer 14 carries a plurality of printed characters 16. The non-transparent layer 14 can be embodied as a coloured etching or a coloured coating. In the embodiment shown in FIG. 1, the printed characters 16 are in readable from only. The second area 10 is spaced apart from the edges of the microscope slide 2.

FIG. 2 shows a second embodiment of a microscope slide 2 according to the present invention. The microscope slide 2 defines three distinct areas. A first area 8 of the microscope slide 2 is provided for the preparation 12. Additionally, the microscope slide 2 has a second area 10 and a third area 18, each of which is provided with a non-transparent layer 14. The second and third area 10 and 18 with the non-transparent layer 14 are arranged on opposite ends 2a and 2b of the microscope slide 2. A first dashed line 20₁ represents the border between the second area 10 and the first area 8. A second dashed line 20₂ represents the border between the first area 8 and the third area 18.

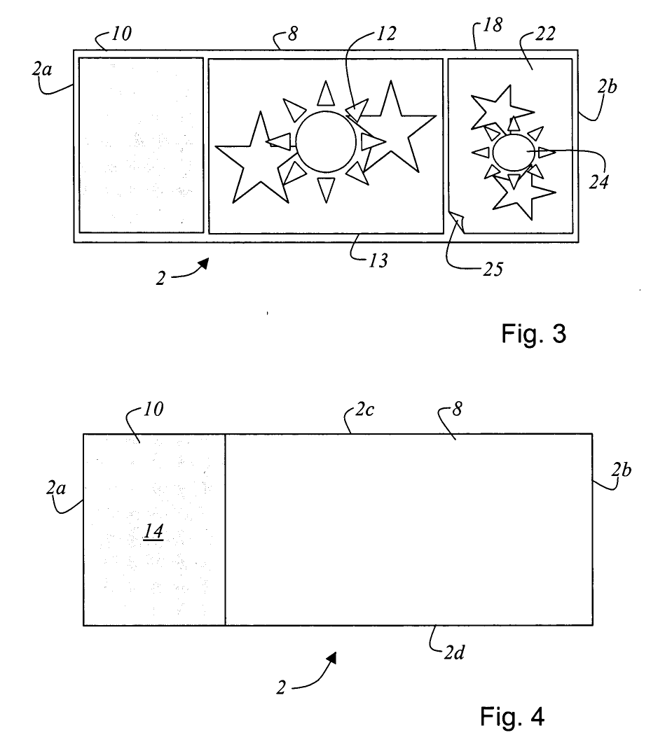

FIG. 3 shows a third embodiment of a microscope slide 2 according to the present invention. The microscope slide 2 defines three distinct areas. A first area 8 of the microscope slide 2 is provided for the preparation 12 which is covered with a cover slip 13. Additionally, the microscope slide 2 has a second area 10 and a third area 18. The second area 10 is provided with a non-transparent layer 14. On the third area 18 a sticker 22 is provided on which a printed representation 24 of the preparation 12 on the microscope slide 2. As already shown in FIG. 2 the second area 10 with the non-transparent layer 14 and the sticker 22 are arranged on the opposite ends 2a and 2b of the microscope slide 2. The sticker 22 is attached to the microscope slide 2 with an adhesive 25.

FIG. 4 shows an embodiment for the arrangement of the second area 10 on the microscope slide 2. Here the non-transparent layer 14 is extended to the one opposite end 2a. The non-transparent layer 14 is extended as well to each of the longitudinal sides 2c and 2d of the microscope slide. As already mentioned above the non-transparent layer 14 on the first area carries a plurality characters in readable and/or in machine readable form.

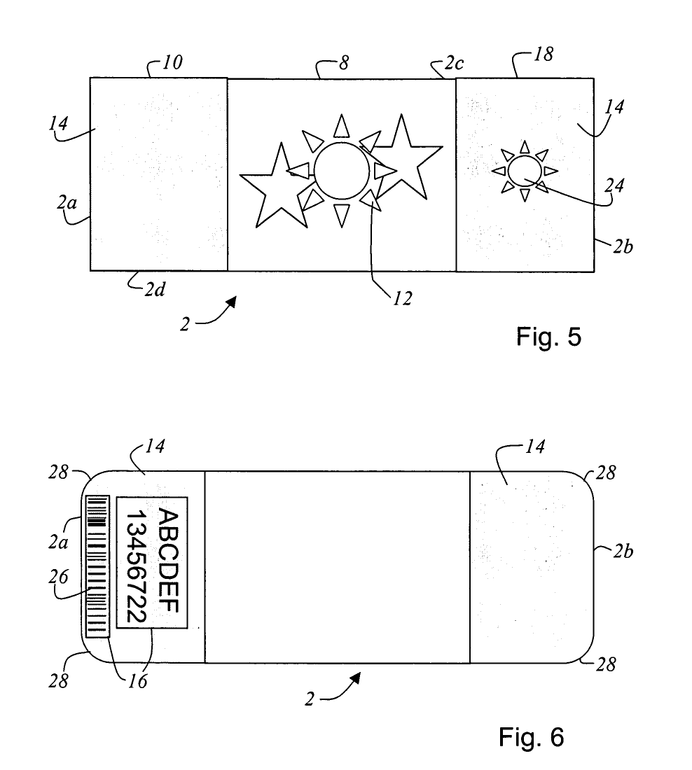

FIG. 5 is a top view of a further embodiment of the present invention. The microscope slide 2 defines three distinct areas. A first area 8 of the microscope slide 2 is provided for the preparation 12. Additionally, the microscope slide 2 has a second area 10 and a third area 18, each of which is provided with a non-transparent layer 14. Both non-transparent coatings 14 are extended as well to each end 2a and 2b and to each of the longitudinal sides 2c and 2d of the microscope slide. One of the non-transparent coatings 14 carries at least a graphical representation 24 of a portion of the preparation 12.

FIG. 6 is a top view of a further embodiment of the microscope slide 2, wherein microscope slide 2 has rounded comers 28. The at least one non-transparent layer 14, which is provided on at least one opposite end 2a or 2b of the microscope slide 2, provide a gripping are for the user of the microscope slide 2 and the rounded comers 28 reduce the risk of any injuries. FIG. 6 shows an additional embodiment of the plurality of printed characters 16 on the non-transparent layer 14. The characters are in readable form and in addition to that characters in machine readable form are added. The characters in machine readable form are represented by a barcode 26. The embodiment shown in FIG. 6 two non-transparent coatings 14 provided on opposite ends 2a and 2b of the microscope slide 2. It has to be understood that the arrangement shown here is only one example and should not be regarded as a limitation of the scope of the invention.

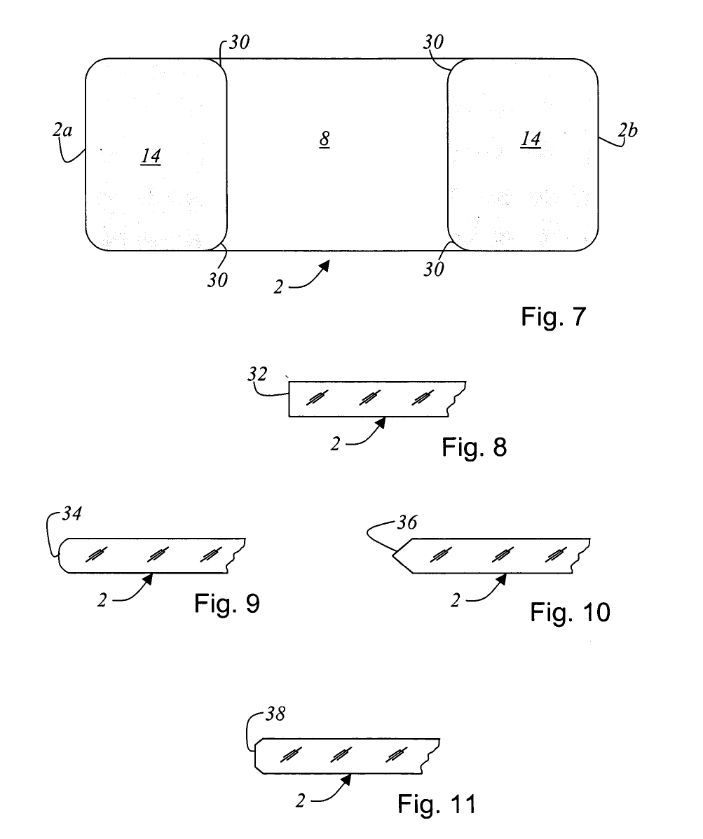

FIG. 7 is a top view of a further embodiment of the arrangement of the non-transparent coatings 14. The transparent coatings 14 have rounded corner 30 on the side which is facing the first area 8 of the microscope slide.

FIG. 8 is an embodiment of the microscope slide 2 with a rectangular edge 32. The rectangular edge 32 surrounds the whole microscope slide 2.

FIG. 9 is an embodiment of the microscope slide 2 with a rounded edge 34. The rounded edge 32 surrounds the whole microscope slide 2.

FIG. 10 is an embodiment of the microscope slide 2 with a triangular edge 36. The triangular edge 32 surrounds the whole microscope slide 2.

FIG. 11 is an embodiment of the microscope slide 2 with a trapezoidal edge 38. The trapezoidal edge 32 surrounds the whole microscope slide 2.

The invention has been described with respect to specific embodiments. It has to be understood that skilled person can carry out variations and modifications without leaving the scope of the claims below.

1. A microscope slide for educational purposes comprising: a transparent material in a rectangular shape, having a first, a second area, and a third area defined on the microscope slide, wherein the first area carries a preparation and the second and third areas are provided with a non-transparent layer, and wherein one of the non-transparent layers carries a plurality of printed characters in readable form and the other nontransparent layer carries a printed representation of the preparation on the microscope slide.

2. The microscope slide as defined in claim 1 wherein the plurality of printed characters comprises readable information.

3. The microscope slide as defined in claim 1 wherein the plurality of printed characters comprises machine readable information.

4. The microscope slide as defined in claim 1 wherein the plurality of printed characters comprises readable and machine readable information.

5. (cancelled)

6. The microscope slide as defined in claim 1 wherein the two distinct areas with the non-transparent layer are arranged in that both non-transparent coatings are arranged on opposite ends of the microscope slide.

7. (cancelled)

8. The microscope slide as defined in claim 1 wherein one of the non-transparent coatings carries the plurality of printed characters in machine readable form and the other non-transparent layer carries a printed representation of the preparation on the microscope slide.

9. The microscope slide as defined in claim 1 wherein one of the non-transparent coatings carries the plurality of printed characters in readable and machine form and the other non-transparent carries a printed representation of the preparation on the microscope slide.

10. The microscope slide as defined in claim 1 wherein the microscope slide has four rounded corners.

11. The microscope slide as defined in claim 1 wherein the microscope slide has a surrounding edge which has a rounded form.

12. The microscope slide as defined in claim 1 wherein the microscope slide has a surrounding edge which has a triangular form.

13. The microscope slide as defined in claim 1 wherein the microscope slide has a surrounding edge which has a trapezoidal form.

14. The microscope slide as defined in claim 1 wherein the least of the non-transparent layers on the microscope slide is a gripping area for handling the microscope slide.

15. A microscope slide for educational purposes comprising: a
transparent material in a rectangular shape, at least a first, a second and a third area defined on the microscope slide, wherein the first area carries a preparation and the second and the third area are provided with a non-transparent layer, a plurality of printed characters are carried on the second non transparent layer and a printed representation of the preparation on the microscope slide is provided on the third non transparent layer.

16. The microscope slide as defined in claim 15 wherein the printed characters and the printed representation of the preparation are done in one color.

17. The microscope slide as defined in claim 15 wherein the one color is black.

18. The microscope slide as defined in claim 15 wherein the second and the third area are arranged on opposite ends of the rectangular slide and the first area is arranged between them.

19. A microscope slide for educational purposes comprising: a transparent material in a rectangular shape, at least a first, a second and a third area defined on the microscope slide, wherein the first area carries a preparation, the second area is provided with a non-transparent layer wherein a plurality of printed characters are carried on the second non transparent coating, and the third area carries a sticker on which a printed representation of the preparation on the microscope slide is shown.

20. The microscope slide as defined in claim 19 wherein the printed representation of the preparation is printed in color on the sticker.

21. The microscope slide as defined in claim 19 wherein the sticker is printed separately and is attached after the printing process to the microscope slide.

22. The microscope slide as defined in claim 19 wherein the second area and the sticker are arranged on opposite ends of the rectangular slide and the first area is arranged between them.
